(19) United States
(12) Patent Application Publication
(10) Pub. No.: US 2018/0070608 A1
(43) Pub. Date: Mar. 15, 2018

(54) APPARATUS FOR THE TREATMENT OF SOLVENT EXTRACTION RESIDUE

(71) Applicant: Desmet Ballestra Engineering n.v./s.a., Zaventem (BE)

(72) Inventors: Marc Kellens, Muizen (BE); Timothy G. Kemper, Marietta, GA (US)

(21) Appl. No.: 15/703,390

(22) Filed: Sep. 13, 2017

(30) Foreign Application Priority Data
Sep. 14, 2016 (GB) GB 1615600.2

(51) Int. Cl. A23J 1/14; A23L 11/30; F26B 17/00; F26B 17/14; F26B 25/00; F26B 25/18; C11B 1/10

(52) U.S. Cl. CPC A23J 1/144; A23L 11/32; F26B 17/003; C11B 1/108; F26B 25/006; F26B 25/18; F26B 17/1408

(57) ABSTRACT

The invention relates to an apparatus for the treatment of spent material said treatment including the desolventisation and toasting of said spent material (DT) to yield desolventized spent material and/or the drying and cooling of said desolventized spent material (DC) to yield meal and/or their combination (DTDC), said apparatus being made of stacked trays supporting said spend material said apparatus being equipped with means to provide at least one fluid phase going through said spent material, wherein at least a portion of the said at least one fluid phase is pulsed through said spent material.

### FIELD OF THE INVENTION

The invention relates to an apparatus for the treatment of spent material, said treatment comprising the steps of the desolventizing and toasting of said spent material to yield desolventized spent material and/or the drying and cooling of said desolventized spent material to yield meal, wherein the apparatus comprises a vessel with an inner volume, said inner volume comprising two or more compartments stacked on top of each other in axial direction, each compartment comprising a tray for receiving spent material to be desolventized and toasted and/or dried and cooled, each tray being equipped to permit downward movement of spent material towards an outlet for the spent material. In particular, the invention relates to an apparatus for the desolventizing toasting and/or drying cooling of a spent material, in particular a spent material in the form of a solvent extraction residue obtained from the solvent extraction of oleaginous material. More particularly, the invention relates to a desolventizer toaster, a dryer cooler or a combined desolventizer toaster dryer cooler wherein an improved desolventizing toasting and/or improved drying cooling of a spent material, in particular an extraction residue obtained from the solvent extraction of oleaginous material, may be achieved by contacting the spent material with a pulsed fluid flow.

### BACKGROUND OF THE INVENTION

Solvent extraction of oleaginous material, such as soybean, sunflower or rapeseed usually yields a miscella which contains about 35% of oil in solvent (usually hexane) and a residue or spent material. The spent material is mostly a substantially defatted material containing about 20-35% of solvent. After careful desolventizing, toasting, drying and cooling of the spent material, a meal is obtained that is suitable for use as feed for animals or as raw material for other extraction processes yielding protein concentrates or isolates for example.

The removal and recovery of the solvent contained in the spent material is an important operation of a solvent extraction facility, since it determines to a large extent the quality of the meal and its derivatives. Solvent removal and recovery also has an important influence on the commercial and environmental performance of a solvent extraction facility. The complete solvent removal and its recovery is namely an energy consuming operation as it requires the use of large amounts of steam, hot air and electrical power.

CN204987757 discloses a camellia seed plate drying device which comprises a box with a plurality of vertically spaced apart receiving plates. At least one upright heat flow conduit extends through the plates and communicates with each of the plates, to ensure that oil tea seed positioned on the receiving plates may be heated. The box contains a humidity detector and is equipped such that when the humidity of the tea seed is between 12-15%, steam is supplied to the interior of the box. When the oil tea seed moisture is 5-7% pulsed heating is provided by the far-infrared heating device provided at the bottom and top of the device.

Solvent removal from spent material is conventionally realized using a thermal process carried out in a piece of equipment called a desolventizer toaster (DT). In a desolventizer toaster spent material is contacted with steam with the purpose of heating the spent material and stripping the solvent therefrom. After a proper desolventizing and toasting has been carried out, the meal which results from that process is dried and cooled in a piece of equipment called Dryer Cooler (DC). Drying and cooling is usually carried out using successive streams of hot and cold air.

In practise, the desolventizer toaster and the dryer cooler are often conceived as two standalone pieces of equipment which are connected together by a conveyor. In many instances, a desolventizer toaster is combined with a dryer cooler in a single piece of equipment called Desolventizer Toaster Dryer Cooler (DTDC). Meal resulting from the treatment of the spent material which leaves the dryer cooler or the desolventizer toaster dryer cooler is sufficiently dry, cooled, desolventized and toasted for safe conditioning and transportation. The meal obtained from such treatment has an extended shelf-live and can be advantageously used as feed for farming animals for example or as starting material for other extraction processes to yield protein concentrates or isolates suitable for humans.

In a desolventizer toaster, the spent material is heated to about 105° C. to induce the evaporation of the solvent contained in the spent material, usually hexane. Given the quantity of material to be heated which may exceed 50 tons per hour in some large oil mills, the vulnerability of the spent material to over-heating, and the requisite to recover the totality of the solvent, a desolventizer toaster needs to be specifically and carefully designed.

The most common type of desolventizer toaster used in the art is represented in FIG. 1. This typical, known desolventizer toaster consists of a cylindrical vessel comprising a stack of several cylindrical compartments (21 to 28) stacked on top of each other in height direction. Each compartment is delimited by a tray (29 to 36) and fitted with a rotatable stirrer (37) attached to a central upright extending shaft (38). The rotating stirrers spread the material to be desolventized over the trays and provide a gentle mixing action to the material. Spent material (39), often straight from the solvent extractor and having a temperature of about 60° C., in particular in case of hexane extraction, is fed at the top of the desolventizer toaster in the uppermost compartment (21) and positioned on the uppermost top tray (29). The upper trays (29, 30, 31) extend in radial direction of the vessel, over part of the diameter of the vessel only. The lower trays (32, 33, 34, 35, 36) to the contrary extend over substantially the full diameter of the vessel, and in other words they extend up to the walls of the desolventizer toaster vessel. Each lower tray is equipped with an adjustable-speed rotating valve (40-44), to permit downward movement of the material, through each lower tray, at the desirable rate but prevent the passage of rising steam. The upper trays (29, 30, 31) are provided with a hole to permit the downward movement of the spent material which is constantly pushed by the rotating stirrers. The spent material is not represented on FIG. 1 to not obscure the description.

To heat the spent material, generally two heating methods are simultaneously used. A first method makes use of direct steam heating or so called heating with contact steam which directly contacts the spent material. A second method makes use of indirect steam heating wherein the trays are equipped with double bottoms acting as steam jackets to which steam is supplied (not shown). In a method where use is made of direct steam heating, hot live steam or “contact steam” (46) is generated in a boiler (45) and is injected into the spent material mass to flow in upward direction via a hollow chamber sparging tray (35). The contact steam (46) ascents (47) through the spent material via small holes provided in the floor of the lower trays (40 to 43). The size and shape of the holes are optimized to favour the flow of the contact steam as much as possible while minimizing the ingress of the spent material into those holes. The vapours loaded with solvent exit the vessel via a top vent (48).

Since heat transfer from the heated surface of the trays floor to the spent material is slow and difficult, especially considering the spent material bed height (up to about 0.5-0.6 meter) loaded in each compartment, the use of contact steam is highly preferred. However, whereas the direct contact between the solid spent material and contact steam provides a more efficient heating, the downside is that condensation of the contact steam in the spent material adds moisture to it that must be removed afterwards in the dryer cooler. Of course, as the spent material progresses in the desolventizer toaster, its temperature increases and therefore part of the contact steam will not condense on the spent material but will instead exert a stripping action to remove further solvent. This stripping action occurs predominantly in the lower trays. Simultaneously with being stripped from solvent by the steam, the spent material is toasted. Indeed, the combined action of heat and moisture induces the inactivation of the trypsin inhibitor along with the denaturation of some proteins which enhances the quality and the palatability of the meal to animals.

The dryer-cooler (DC) is a device which is similar to the desolventizer toaster in relation to its construction, but a dryer cooler usually has a smaller height since it usually contains less compartments, often only two compartments: a first compartment where the spent material leaving the desolventizer toaster which contains about 20% of water is dried using hot air, and a second compartment where cold air is used to cool the spent material that becomes the final meal. Each compartment is equipped with a stirrer. In a dryer cooler, air is blown through the material via the pierced floor which delimits each compartment: hot air emerges from the upper pierced floor and rises through the spent material in the upper compartment, while cold air emerges from the lower pierced floor and rise through the spent material in the lower compartment. A typical dryer cooler is described for example in U.S. patent application Ser. No. 12/449,703.

A desolventizer toaster dryer cooler (DTDC) is a combination in one single vessel of a desolventizer toaster and a dryer cooler, as previously described, with the desolventizer toaster being positioned on top of the dryer cooler.

In the field, the above-described devices are known under the name of Dimax DT, Dimax DC or Dimax DTDC supplied by Desmet Ballestra (Belgium). Similar equipment's are also supplied by Crown Iron Works (USA). As a matter of fact, they all root from an equipment developed in Germany by Schumacher (U.S. Pat. No. 4,622,760) that has been continuously improved over the years.

The present invention relates to such desolventizer toaster, dryer cooler or desolventizer toaster dryer cooler comprising several trays stacked on top of each other as described above. The present invention relates to a desolventizer toaster and/or a dryer cooler when conceived as stand alone equipment or when combined into one apparatus known as a desolventizer toaster dryer cooler.

In order to permit an efficient and economic use of the fluid phase, an optimisation of the contact between the fluid phase (which is usually contact steam in the desolventizer toaster and air in the dryer cooler) and the spent material is paramount.

Unfortunately, the equipment and processes known in the art present several shortcomings, which induce an over-consumption of the fluid phase used to achieve desolventizing and/or drying and/or cooling. The main shortcomings of the prior art equipment are channelling of the fluid phase in the spent material and the formation of fluid phase pockets in the spent material. With channelling is meant the formation of preferential passages of the fluid phase through the mass of the spent material. The larger the passages, the more the fluid phase is lost. Pocket formation is a phenomenon similar to channelling, with the exception that the fluid phase remains blocked in the mass of spent material until explosion of the fluid phase pockets takes place. Again the larger the pocket, the more the fluid phase is lost.

Pocket formation and channelling are attributed to the fact that the stirrers fitted in each compartment apparently do not rotate fast enough to permit achieving a thorough mixing of the spent material, and thereby avoid channelling and formation of pockets of the fluid phase. Indeed, the stirrer which is moving in the mass of the spent material is arranged to gently stir this mass with the purpose of avoid its cooking on the heated bottom of each compartment. The function of the stirrer is also to push the spent material mass regularly from one compartment to the next one and to respect as much as possible the ‘first in first out’ principle. Thereby, violent mechanical agitation is unwanted since this would increase the risk to dust and fines formation, and also require substantial power and an overly sturdy construction of the stirrers, shaft, engine and gears penalising both the building and the operational costs. And even with such costly overly sturdy construction of the stirrers, shaft, engine and gears, it is not demonstrated that the contact between the spent material and the fluid phase will be substantially improved.

Therefore there is a need for improved equipment which permits to improve the contact between the fluid phase and the spent material to be desolventized and toasted and/or dried and cooled.

### OBJECT OF THE INVENTION

It is therefore an object of the invention to provide an improved apparatus for the desolventizing, toasting, drying and cooling of spent material, which is capable of providing an improved contact between the fluid phase and the spent material compared to existing equipment.

### SUMMARY OF THE INVENTION

It has surprisingly been found that the above objects can be attained with an apparatus as described in the characterising portion of the first claim.

Thereto, the apparatus of the present invention is characterised in that a lower part of the vessel is equipped with at least one inlet for supplying at least one fluid phase and causing said fluid phase to move in upward direction of the vessel with the purpose of desolventizing and toasting and/or drying and cooling said spent material, wherein the apparatus comprises a pulsating member for causing at least a portion of the said at least one fluid phase to be supplied in a pulsating manner.

The inventors have observed that the presence in the apparatus of the present invention of the pulsating member for causing at least a portion of the said at least one fluid phase to be supplied in a pulsating manner, provides an improved equipment for the desolventizing and toasting and/or drying and cooling of the spent material. In such an apparatus namely, the amount of fluid phase needed to achieve desolventizing and toasting and/or drying and cooling of spent material may be significantly reduced in comparison to existing equipment's of the prior art. In particular, the inventors have observed that when the apparatus of the present invention is used as a desolventizer toaster for desolventizing spent material, the amount of steam consumed to achieve desolventizing and toasting, may be significantly reduced in comparison to existing equipment's of the prior art. The inventors have also observed that the apparatus of the present invention when used as a dryer cooler for the drying and cooling of spent material, in particular desolventized spent material, consumes less air than existing equipment's of the prior art.

The apparatus of the present invention presents the advantage that when used for the desolventizing, toasting, drying and cooling of spent material energy consumption may be reduced when compared to existing equipment, and that it may be made much more compact in comparison to prior art equipment.

As a result, an apparatus may be provided which, when operated to provide an optimum compromise between implying a sufficient movement to the spent material and at the same time minimise the risk to dust formation, also permits to optimise fluid phase consumption to achieve desolventizing and/or drying and/or cooling of the spent material.

A lower part of the vessel preferably comprises a sparging compartment comprising a sparging tray, which sparging tray is provided with holes for guiding the fluid there through in upward direction of the vessel, wherein at least a portion of the fluid phase subjected to pulsation is supplied to the sparging compartment via the sparging tray or directly in the sparging compartment. This permits realising a dense and homogenous contact between the fluid phase and the spent material and a more efficient solvent stripping and/or drying and/or cooling of the spent material. The holes are preferably numerous and small, to permit providing tiny bubbles of the fluid phase and increase the surface contact between the fluid phase and the spent material.

To minimise the risk to subjecting the spend material to any unwanted movement and minimise the risk to dust formation, preferably at least a portion of the pulsed fluid is supplied in the sparging tray in a non-pulsed mode.

Causing at least a portion of the said at least one fluid phase to be supplied in a pulsating manner may be achieved in various ways.

According to a first preferred embodiment, this is achieved with an apparatus which comprises a first duct for conducting a first portion of the flow of the fluid phase which is not subjected to pulsation to a first fluid phase inlet of the vessel, and a second duct for conducting a second portion of the flow of the fluid phase subjected to pulsation to a second fluid phase inlet. Thereby, preferably the first fluid phase inlet is located in the sparging tray, and the second pulsed fluid phase inlet is located in any position above the sparging tray, in particular a position located in the sparging compartment which corresponds to a position above or below the top surface of the layer of spent material loaded on the sparging tray.

According to a second preferred embodiment, the apparatus comprises a first duct for conducting a first portion of the flow of the fluid phase to a supply duct for supplying the fluid phase to the fluid phase inlet of the vessel, and a second duct for conducting a second portion of the fluid phase flow to the pulsation member and further to the supply duct, where the second duct is merged with the supply duct, and the pulsed portion of the fluid phase flow is mixed with the non-pulsed portion.

According to a third preferred embodiment of this invention a lower region of the vessel at a position above the sparging tray is connected to a pressure member, which is arranged to subject the inner volume or interior of the vessel to a pulsating pressure.

Supplying of a portion of the fluid phase in a pulsating manner may be achieved using any technique considered suitable by the skilled person. Preferably however, to this end the apparatus comprises a piston for acting upon a portion of the at least one fluid phase supplied to the vessel and converting at least a portion of said fluid phase into a pulsed fluid phase.

Depending on the specific application for which the apparatus is intended, the fluid phase may either be steam and/or air, although any other fluid phase considered suitable by the skilled person and capable of achieving desolventizing and/or drying and/or cooling of spent material, may be used as well.

The present invention also relates to a method for the treatment of oleaginous spent material, said treatment comprising the steps of desolventizing and toasting of said spent material to yield desolventized spent material and/or the drying and cooling of said desolventized spent material to yield meal, wherein spent material is supplied to an upper compartment in an inner volume of a vessel and moved to lower compartments located below the upper compartment, each compartment comprising a tray for receiving spent material to be desolventized and toasted and/or dried and cooled, which method is characterised in that a flow of at least one fluid phase is supplied to a lower part of the vessel and caused to move in upward direction of the vessel with the purpose of desolventizing and toasting and/or drying and cooling said spent material, wherein at least a portion of the said at least one fluid phase is supplied in a pulsating manner.

According to a preferred embodiment of the invention the entire fluid flow is supplied in a pulsating manner. According to another preferred embodiment of the invention a portion of the fluid phase flow is subjected to pulsation, in particular 10-90 volume % of the fluid phase flow is supplied in a pulsating manner, preferably 20-80 volume %.

Other aspects and advantages of the present invention will become apparent from the detailed description of the invention hereinafter.

### BRIEF DESCRIPTION OF THE DRAWINGS

FIG. 1 depicts a standard desolventizer toaster as currently used in the art;

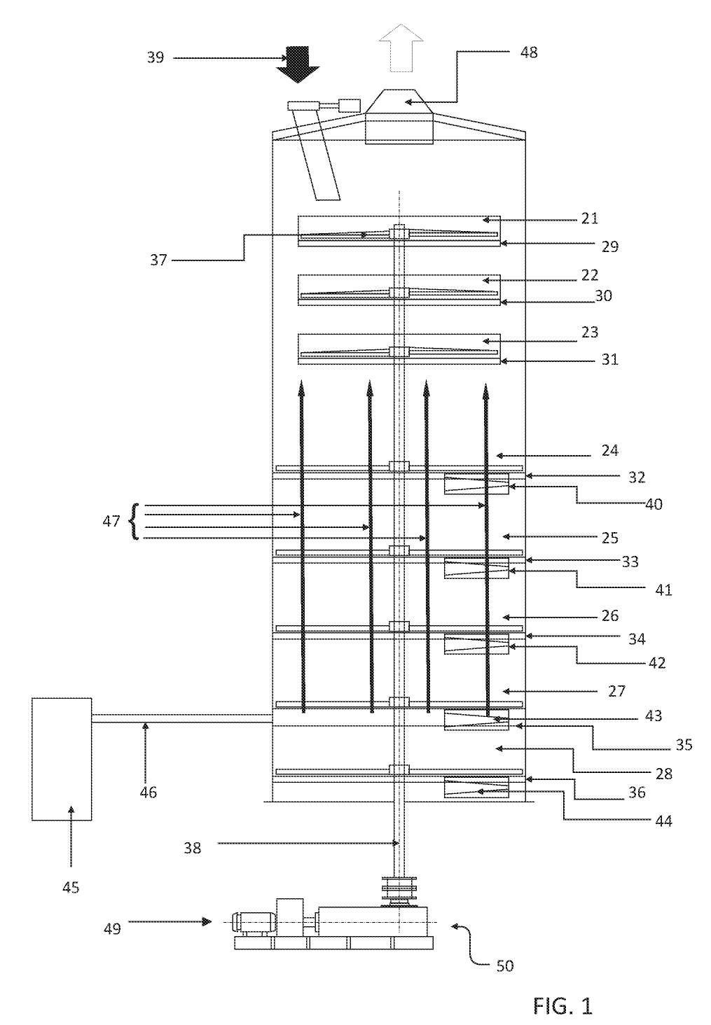

FIGS. 2 shows a preferred embodiment of a desolventizer toaster of the present invention;

FIG. 3 shows a preferred embodiment of a desolventizer toaster of the present invention; and

FIG. 4 shows a preferred embodiment of a desolventizer toaster of the present invention.

However the present invention is not limited by those figures but only by the claims. The spent material is not represented in those figures to not obscure the description.

### DEFINITIONS

DT. In the context of the present invention, “DT” refers to a desolventizer toaster comprising a vessel with several trays stacked above each other in axial direction of the vessel. Spent material is supplied to the top of the desolventizer toaster and moved in downward direction from the top tray to the bottom tray while steam is rising in upward direction and contacts the spent material to strip solvent contained in the spent material.

DC. In the context of the present invention, “DC” refers specifically to a dryer cooler comprising a vessel which contains at least two stacked trays stacked above each other in axial direction of the vessel. Spent material, in particular desolventized spent material, is supplied to the top tray and moved downwards from the top tray to the bottom tray while hot air is rising upwards and contacts the spent material in the top tray, while cool air is rising upwards and contacts the spent material in the bottom tray.

DTDC. In the context of the present invention, “DTDC” refers specifically to a desolventizer toaster dryer cooler, which is a combination of a desolventizer toaster and dryer cooler in a single vessel, wherein the desolventizer toaster is positioned on top of the dryer cooler.

Spent material. In the context of the present invention, “spent material” refers to the solid residue resulting from the solvent extraction of oleaginous material such as for example soybean, sunflower or rapeseed. The “spent material” encompasses the material coming directly from the solvent extractor as well as the material that may have undergone a preliminary partial desolventizing in a flash vessel. In the context of the invention “spent material” also encompasses all the intermediate and final materials that are processed in a desolventizer toaster, dryer cooler or DTDC and that, for example, may be partially desolventized but still not toasted, dried and cooled or that may be desolventized, toasted, dried but still not cooled. In the context of the invention “spent material” also encompass the desolventized spent material that is desolventized and toasted but not dried and cooled and further encompass the meal that is the final material exiting the dryer cooler or DTDC that is desolventized toasted dried and cooled.

Fluid phase. In the context of the present invention, “fluid phase” encompasses any fluid used to contact the spent material and achieve desolventizing and/or toasting and/or drying and/or cooling. Particularly preferred fluid phases in the context of this invention are steam, hot and cool air, more particularly the contact steam used in the desolventizer toaster or DTDC and the hot and cold air used in the dryer cooler or DTDC.

### DETAILED DESCRIPTION OF EXEMPLARY EMBODIMENTS

The inventors have surprisingly found that the flow and flow distribution of the fluid phase in the apparatus of this invention, in particular the distribution of the fluid phase flow through the spent material can be improved by the presence of a pulsating member, which causes at least a portion of the at least one fluid phase which is provided to contact the spent material, to be supplied in a pulsating manner.

In particular, the inventors have observed that by the presence of a pulsating member which causes at least a portion of the at least one fluid phase to be supplied in a pulsating member, an improved distribution of the fluid phase through the layers of spent material contained in the trays may be achieved, and that as a result thereof, the desolventizing efficiency may be improved. More in particular it has been observed that the quantity of fluid phase, in particular steam, needed to achieve a certain degree of desolventizing of the spent material may be reduced. Alternatively, when using the same amount of fluid phase it has been observed that residual solvent in the desolventized spent material may be reduced with similar stripping time. Alternatively, when using the same amount of fluid phase in order to achieve a certain level of residual solvent in the desolventized spent material, stripping time or in other words the time during which the spent material needs to be contacted with the fluid phase in order to achieve a certain degree of desolventizing, may be reduced.

The present invention thus permits to reduce the residence time of the spent material in the apparatus, which translates into an increased capacity of a given apparatus. In the case of a desolventizer toaster, the reduced stripping time or residence time of the spent material may also translate into an improvement in the protein digestibility index of the oilseed meal (PDI).

The present invention shows the additional advantage that a pulsating member for causing at least a portion of the at least one fluid phase to be supplied in a pulsating manner permits to reduce the volume occupied by the apparatus, and may result in an equipment that is more compact than the prior art equipment. A more compact apparatus may for example be achieved by the presence of trays of smaller diameter or a smaller number of trays compared to a desolventizer toaster of the prior art.

It has further been found that supplying of at least a portion of the fluid phase in a pulsating manner permits to minimise the risk to the occurrence of channelling and the risk to the formation of fluid phase pockets in the mass of the spent material without requiring an increased motion of the spent material. This is advantageous as it is important that motion implied to the spent material is such that an optimal compromise is provided between inducing a sufficient motion to the spent material on the one hand and avoiding dust formation on the other hand.

The effects described above have been observed to occur when use is made of steam as a fluid phase and the apparatus is a desolventizer toaster. A dryer cooler will benefit similarly on the embodiments previously described, except that as the fluid phase use will be made of air and a least a fraction of this air will be supplied in a pulsating manner. Air is generally introduced through a double bottom pierced floor of a tray. A dryer cooler using at least a fraction of pulsed air rising through the spent material will reduce the quantity of the air needed to dry and cool a given amount of spent material, preferably desolventized spent material.

However, the frequency, amplitude with which pulsed air is supplied to the vessel to achieve drying and/or cooling of spent material, and the portion which is supplied as a pulse in relation to the total air flow supplied to the vessel in a dryer cooler, may be related to but must not necessarily related to the setting selected in the desolventizer toaster according to the present invention. Or in other words the ratio between the fluid phase flow that is subjected to pulsation and the fluid phase flow that is not subjected to pulsation may be the same or different for a desolventizer toaster and a dryer cooler. Similarly the amplitude and/or frequency with which the fluid phase flow is pulsed may be the same or different for a desolventizer toaster and a dryer cooler.

The pulsed portion of the fluid phase may be introduced in the apparatus of this invention in different ways. Many devices are known to the skilled person which are capable of supplying a fluid phase in a pulsating manner, and in a preferred embodiment this may be achieved by the use of a piston. The skilled person will be capable of appropriately selecting the appropriate type of piston taking into account the properties of the pulses, in particular the frequency and amplitude of the pulses, the dimensions of the apparatus and the amount of spent material to be treated, and of adjusting the properties of the pulses to match the resonance frequency of the spent material particles if required or found more efficient. With amplitude is meant in the framework of this invention, the amount of fluid phase provided at a certain point of time in the pulse.

According to a first preferred embodiment of this invention, which is particularly suitable for use with a desolventizer toaster where steam is used as the fluid phase, the pulsed portion of the fluid phase is supplied to the apparatus through a sparging tray arranged in a lower part of the vessel. The fluid phase may be supplied directly in a compartment of the desolventizer toaster, preferably the compartment above and adjacent to the sparging tray in axial direction of the apparatus (sparging compartment). In a preferred embodiment, the pulsed portion of the fluid phase is provided by the presence of a piston which is connected to a compartment of the desolventizer toaster, preferably the compartment above and adjacent to the sparging tray.

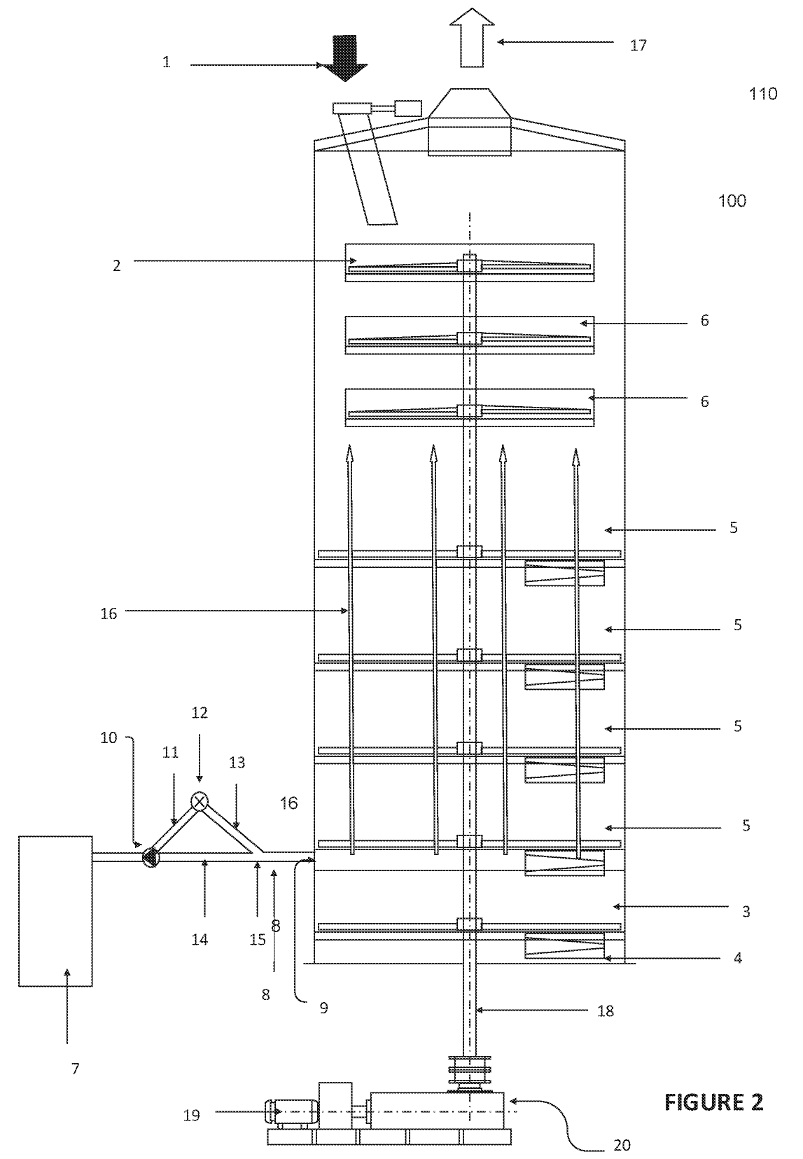

The invention will be further described based on FIGS. 2, 3 and 4, which represent several preferred embodiments of the invention applied to a desolventizer toaster. However a dryer cooler or a desolventizer toaster dryer cooler can benefit of the present invention as well.

FIG. 2 shows a desolventizer toaster as a preferred embodiment of the present invention.

A desolventizer toaster such as the one shown in FIG. 2 generally comprises a vessel 110 with an inner volume 100, wherein two or more compartments are stacked on top of each other in axial direction of the vessel. Each compartment comprises a tray 5 for receiving spent material to be desolventized and toasted and/or dried and cooled. Each tray is equipped to permit downward movement of spent material towards a bottom tray and further to an outlet for discharging the spent material from the vessel.

Spent material (solvent extraction residue) leaving the solvent extraction process usually contains about 20-35% solvent by weight (usually hexane) and enters the desolventizer toaster through a gate 1 in an upper part of vessel 110. Optionally the spent material exiting the solvent extraction process may have undergone a partial desolventization in a flash vessel to reduce its solvent content to less than about 10% by weight before being fed to the desolventizer toaster of the present invention. The connection between the desolventizer toaster and the solvent extractor or the flash vessel is preferably hermetic to preclude any solvent loss and any air ingress into the desolventizer toaster.

The spent material entering the desolventizer toaster along gate 1 usually has a temperature of about 60° C. and therefore steam supplied to the vessel and contacting the spent material, will condense into said spent material. The spent material progresses through the desolventizer toaster from the uppermost tray 2 to a bottom tray 3. In a preferred embodiment, bottom tray 3 is a flash tray where a depression or reduced pressure is created to flash evaporate the last trace of solvent present in the spent material. However the present invention does not depends on the presence or absence of such a flash tray.

As the spent material reaches the bottom of the vessel and has been desolventized and dried it is discharged from the desolventizer toaster 4 to be dried and cooled in a dryer cooler (not shown). During the progression of the spent material through the desolventizer toaster, the spent material is progressively heated so that the solvent contained in the spent material is thermally removed. Approximately 30% of the heat is supplied by steam entering steam heated trays (this steam is not supplied in a pulsating manner), wherein the trays ensure indirect heating 2,6 of the spent material, while approximately 70% of the heat is supplied by contact steam which is flown through and directly contacts the spent material. The contact steam, at least part of which may be supplied in a pulsating manner, will strip the solvent contained in the spent material when this one has a sufficiently high temperature. However, when the temperature of the spent material is not sufficiently high, the contact steam risks to condense into the spent material. The solvent stripping mostly takes place in the bottom trays, which extending up to the wall of the desolventizer toaster 5 while the steam condensation mostly takes place in the top trays 2 and 6, often mainly in the uppermost top tray 2.

The apparatus further contains a steam generator 7 such as a boiler for example, for supplying the contact steam 8 to the vessel 110. Contact steam usually enters the desolventizer toaster via a hollow chamber sparging tray 9, which sparging tray contains a series of drilled holes in the upper surface of said sparging tray to permit fine steam flows to be released in the vessel.

In a first preferred embodiment of the present invention, steam is supplied to a control valve 10 arranged to split the steam for into a first flow 11 which is supplied to a pulsating member, for example a rotary valve 12, to create a pulsed contact steam flow 13, and a second steady steam flow 14. Both flows are merged 15 before being supplied to the sparging tray 9. This arrangement allows to tune the percentage of the pulsed contact steam going through the spent material from 0 to 100%, i.e. to provide a steam flow which is not pulsed up to a steam flow which is fully pulsed.

The pulsed contact steam then ascends 16 through the spent material layers laying on each trays and through openings made in all said trays above the sparging tray. Those openings are designed to allow the passage of steam with minimum pressure drop while preventing as much as possible the passage of the meal. The majority of the steam condenses in the uppermost deep tray 2 and then the solvent vapour exits the top of the desolventizer toaster 17. While the steam ascends, the meal descends, via adequate gates or holes, from tray to tray while being gently moved by stirrer mounted on a central rotating shaft 18 actioned by an electric engine 19 fitted with the adequate gearing 20.

The flow of pulsed contact steam is typically adjusted automatically to maintain a target vent temperature of the vapours exiting the top of the desolventizer toaster 17.

The contact steam passes up through the spent material at a density of about 200-800 kg/h/m2, and ideally at a density of about 500 kg/h/m2. The contact steam density range is preferably selected such a way that it is right below the fluidization velocity of the spent material. It is important to minimise the risk to the occurrence of such fluidization because this would lead to the generation of unwanted fines and dust and would reduce the efficiency of the steam solvent stripping. Besides the contact steam density, the proportion of the contact steam that is pulsed, its frequency and amplitude may also be taken into account to stay below the fluidisation threshold.

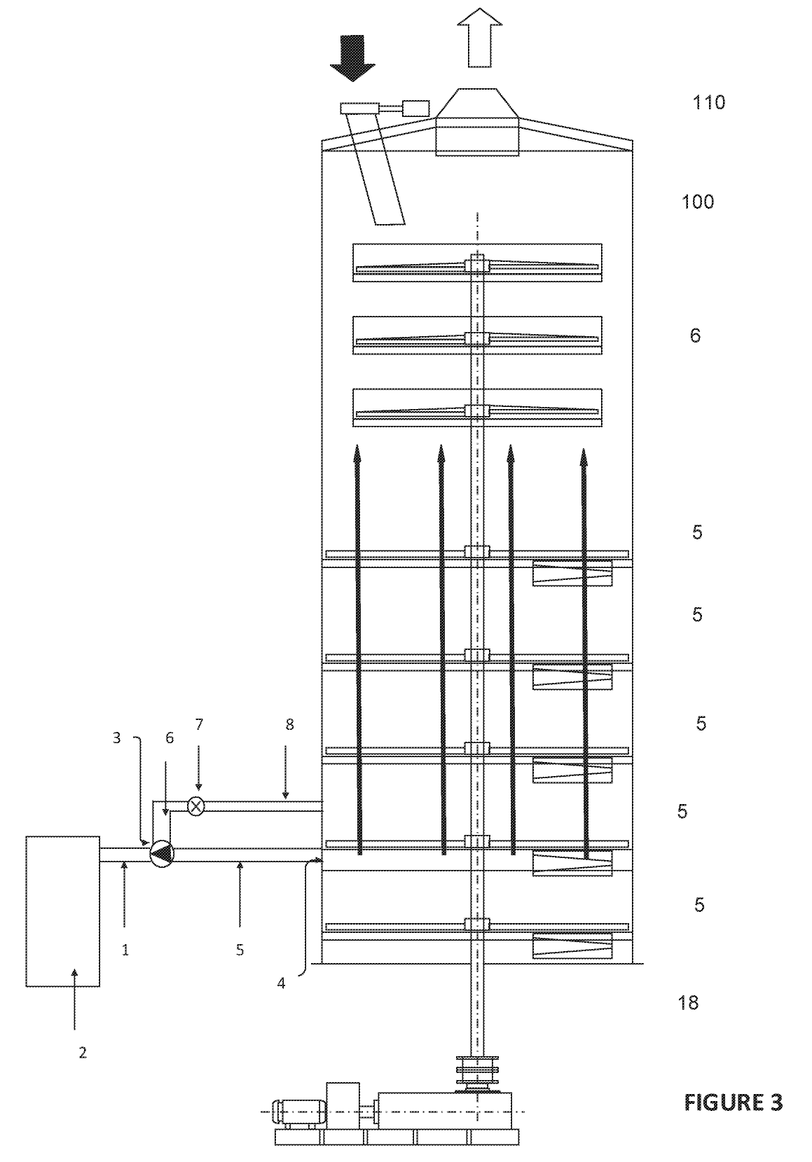

FIG. 3 depicts a second preferred embodiment of the present invention. As indicated on FIG. 3, the steam flow 1 produced by the steam generator 2 is conduct through a first duct 1 towards a device for splitting the flow into a first and a second flow. Hereto, for example use can be made of a control valve 3. Instead of 100% of this flow being supplied to or through the sparging tray 4, at least part of, for example 85-95% of the steam flow 5, is supplied to the sparging tray 4, and 5-15% of the steam flow 6 is supplied to a pulsing device 7. As such, the 5-15% of total direct contact steam flow is injected into the desolventizer toaster above the sparging tray either into or above the spent material layer resting on the sparging tray. A suitable example of a steam flow pulsating member is an EBRO brand rotating vane valve with 6 vanes, but the invention in not limited to such rotating vane. This valve will pass the 5-15% of total direct contact steam flow by being adjusted in the range of 33% to 100% rotational speed, which more specifically is 42 to 14 rpm. With 6 vanes this means 252 to 84 pulses per minute, or 4.2-1.4 pulses per second, or 4.2-1.4 hertz pulse frequency. Those setting are only illustrative and are not intended to limit the scope of the present invention.

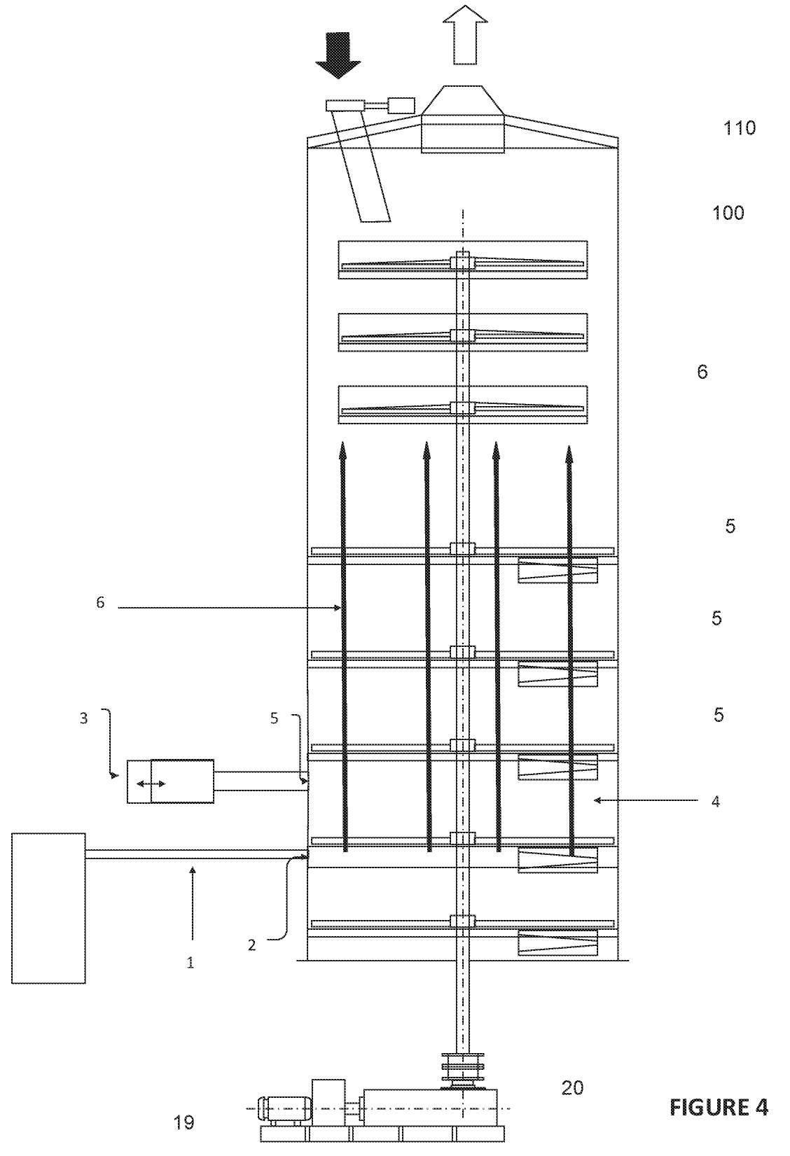

FIG. 4 depicts a third preferred embodiment of the invention. In this embodiment, the contact steam flow 1 is injected in the sparging tray 2 and is not pulsed. The pulsation is created by at least one pulsating member such as for example a piston 3 connected to at least one compartment preferably to the compartment above and adjacent 4 to the sparging tray 2, the actual connection 5 being made above the spent material layer contained in said compartment. In this case a connection above the layer of spent material is preferred to avoid the contamination of the piston with particles of spent material. Therefore, the contact steam rising through the spent material will be pulsed 6 from this connection point 5. The size of the one or more pistons, the stroke and the frequency will be selected to reach the desired frequency and amplitude of the pulsed contact steam. Alternatively, one or more pistons can be connected to one or more compartments above the compartment directly adjacent to the sparging tray.

In a fourth preferred embodiment, two or more of the above described embodiments may be combined.

The invention will generally make use of rotary vane or piston or any similar means, in order to create a pulsed fluid phase flow moving through the spent material instead of a steady flow of fluid phase moving through the spent material as customary in prior art equipment's. Variable speed rotary valves may be preferred since best results are obtained for particular frequency depending of many factors such as but not limited to the type of desolventizer toaster, dryer cooler or DTDC, its capacity, the type of spent material that is desolventized. In some instance, best results can be obtained for frequency of less than one Hz, while in other circumstances best results can be obtained for frequencies ranging for 1 to 10 Hz although in other situations best results may be observed for frequency exceeding 10 Hz. A particular frequency is the “resonance frequency” or the “resonance”. Resonance is the tendency of a system or material to oscillate with greater amplitude at some frequencies than at others. Frequencies at which the response amplitude is a relative maximum are known as the system or material resonant frequencies, or resonance frequencies or resonance. At these frequencies, even small periodic driving forces can produce large amplitude oscillations, because the material stores vibrational energy. Best performances can be observed at resonance frequencies but not systematically. Indeed, at the resonance frequency, the maximal amplitude of the spent material will be reached. This may correspond to maximal interaction between the fluid phase and the spent material and hence the best thermal exchange. In other circumstances, if the amplitude of the spent material is excessive some fluid phase may be lost and/or create too much dust and fines. As a matter of fact it is important to avoid the fluidization of the spent material and the amplitude of the pulsed fluid phase has to be reduced accordingly.

Although it is within the scope of this invention that the entire fluid phase flow may be subjected to pulsation, it is preferred that only a portion of the fluid phase be pulsated. For example, if a given flow of fluid phase per minute is injected in a given point of a desolventizer toaster, dryer cooler or DTDC, 90% of this flow can by steady and 10% can be pulsated. The optimal percentage of the fluid phase that need to be pulsated depends on many factors such as, but not limited to, the type of desolventizer toaster, dryer cooler or DTDC, its capacity, the type of spent material that is desolventized, the compartment. In some instance, best results are obtained when less than 10% of the fluid phase is pulsated, while in other circumstance best results are obtained when 10 to 30% of the fluid phase is pulsated whereas in other situation best results will be observed when the percentage of the fluid phase being pulsated reach 100%.

As exemplified on FIGS. 2, 3 and 4, the retrofitting of existing installations with a pulsating member for causing at least a portion of the said at least one fluid phase to be supplied in a pulsating manner, is particularly straightforward as it simply involves the installation of regular valves and variable speed rotary valves, or other appropriate means or the installation of a piston or pistons or other appropriate means with suitable piping. As a matter of fact the comparison between a standard DTDC and the same retrofitted DTDC will illustrate the surprisingly substantial performance improvement induced by the present invention. The DTDC is of the stacked type with a capacity of 20 tons per hour of spent material resulting from the solvent extraction of soybeans with hexane and containing 20% of solvent in weight. With a Dimax DT, it has been observed that the amount of contact steam needed to achieve a certain degree of desolventizing, may be reduced with 5%.

It has been observed that, a retrofitted DTDC of the Dimax type with a capacity of 20 tons per hours can produce a meal reaching the target specifications with substantially less fluid phase and particularly less contact steam and hence less energy. If in the desolventizer toaster retrofitted according to the first preferred embodiment exemplified on FIG. 2, 20% of the contact steam is pulsated with a frequency of 10 Hz, a reduction of 10% of consumed contact steam is attained. In the dryer cooler, good results were obtained when 5% of fluid phase (hot air) was pulsated at a frequency of 5 Hz in the top compartment of the dryer cooler. Similarly, in the bottom compartment of the dryer cooler an equivalent reduction of the air needed to cool the spent material has been observed. This example above is illustrative only, the optimum parameters of the pulsed fluid phase, i.e., its frequency, amplitude and devices used to introduce said fluid phase in contact with the spent material (as illustration on FIGS. 2, 3 and 4 for example) depends on many factors including the size and shape of the desolventizer toaster, dryer cooler or DTDC, the nature of the spent material. Similarly the attained performances will depend of the same factors and cannot be calculated theoretically.

1. An apparatus for the treatment of spent material, said treatment comprising the steps of the desolventizing and toasting of said spent material to yield desolventized spent material and/or the drying and cooling of said desolventized spent material to yield meal, wherein the apparatus comprises a vessel with an inner volume, said inner volume comprising two or more compartments stacked on top of each other in axial direction, each compartment comprising a tray for receiving spent material to be treated, each tray being equipped to permit downward movement of spent material towards an outlet for the spent material, characterised in that at least a lower part of the vessel is equipped with at least one inlet for supplying a flow of at least one fluid phase and causing said fluid phase to move in upward direction of the vessel through the spent material with the purpose of desolventizing and toasting and/or drying and cooling said spent material, wherein the apparatus comprises at least a pulsating member for causing at least a portion of the said at least one fluid phase to be supplied in a pulsating manner.

2. An apparatus according to claim 1, wherein a lower part of the vessel comprises a sparging compartment comprising a sparging tray, which sparging tray is provided with holes for guiding the fluid there through in upward direction of the vessel, wherein the vessel comprises, at least an inlet for supplying at least a portion of the fluid phase subjected to a pulsation.

3. An apparatus according to claim 1, wherein the apparatus comprises a first duct for conducting a first portion of the flow of the fluid phase which is not subjected to pulsation to a first fluid phase inlet of the vessel, and a second duct for conducting a second portion of the flow of the fluid phase subjected to pulsation to a second fluid phase inlet.

4. An apparatus according to claim 3, wherein the first fluid phase inlet is located at the sparging tray, and the second pulsed fluid phase inlet is located at a position above the sparging tray, in particular a position which corresponds to a position within the sparging compartment.

5. An apparatus according to claim 1, wherein the apparatus comprises a first duct for conducting a first portion of the flow of the fluid phase to a supply duct for supplying the fluid phase to the fluid phase inlet, and a second duct for conducting a second portion of the flow of the fluid phase to the pulsation member and further to the supply duct, where the second duct is merged with the supply duct.

6. Apparatus according to claim 5, wherein the supply duct supplies fluid phase to the sparging tray.

7. An apparatus according to claim 1, wherein the apparatus comprises a splitter for splitting the fluid phase flow into a first and a second flow, wherein the first flow is conducted to the first duct, and the second flow is guided to the second duct.

8. An apparatus according to claim 1, wherein a lower region of the vessel at a position above the sparging tray, is connected to a pressure member, which is arranged to subject the vessel to a pulsating pressure.

9. An apparatus according to claim 8, wherein the pressure member is a piston.

10. An apparatus according to claim 1, wherein the pulsating member comprises a piston for acting upon a portion of the at least one fluid phase supplied to the vessel and converting at least a portion of said fluid phase into a pulsed fluid phase.

11. An apparatus according to claim 10, wherein said fluid phase is contact steam and/or air.

12. An apparatus according to claim 10, wherein said fluid phase for cooling the spent material is air.

13. An apparatus according to claim 1, wherein the vessel further comprises at a position below the sparging tray in axial direction of the vessel, a flash tray and means for creating a pressure which is lower when compared to a pressure in the remainder of the vessel, at the position of the flash tray.
